(19) United States
(12) Patent Application Publication
(10) Pub. No.: US 2026/0142544 A1
(43) Pub. Date: May 21, 2026

(54) STEPPER MOTOR

(71) Applicant: AAC Microtech (Changzhou) Co., Ltd., Changzhou City (CN)

(72) Inventors: Lubin Mao, Changzhou (CN); Tong Zhang, Changzhou (CN)

(21) Appl. No.: 19/064,654

(22) Filed: Feb. 26, 2025

Related U.S. Application Data
(63) Continuation of application No. PCT/CN2024/133451, filed on Nov. 21, 2024.

(51) Int. Cl. H02K 37/14; H02K 3/32; H02K 3/52; H02K 7/08

(52) U.S. Cl. CPC H02K 37/14; H02K 3/325; H02K 3/525; H02K 7/083

(57) ABSTRACT

The present disclosure provides a stepper motor including: two plates arranged opposite to each other; a rotary shaft having two ends supported on the two plates, respectively; a magnet sleeved on the rotary shaft; and a stator unit sleeved on the rotary shaft. The stator unit includes a plurality of windings fixed between the two plates. Each winding includes two respective claw poles arranged opposite to each other and sleeved on the rotary shaft and at least two respective solenoids fixed between the two respective claw poles, the solenoids are arranged at intervals along a circumferential direction of the rotary shaft, and each solenoid includes a respective iron core fixed between the two respective claw poles and a respective coil wound on the respective iron core. Coils of the plurality of windings that align with each other along the axial direction of the rotary shaft have a same axis.

### CROSS REFERENCE TO RELATED APPLICATIONS

The present application is a continuation of PCT Patent Application No. PCT/CN2024/133451, filed Nov. 21, 2024, which is incorporated by reference herein in its entirety.

### TECHNICAL FIELD

The present disclosure relates to the field of motor technology, and in particular to a stepper motor.

### BACKGROUND

The stepper motors have been widely used in fields such as electric motors and generators due to their high working efficiency and energy-saving advantages.

In related technologies, a stepper motor may have a plurality of winding structures. A multi-winding stepper motor includes a rotary shaft, a magnet fixed to the outer periphery of the rotary shaft, and a plurality of windings that are sleeved on the rotary shaft and in rotational connection with the rotary shaft. Each winding includes two respective claw poles and a respective coil sleeved on the two respective claw poles.

In the above-mentioned multi-winding stepper motor, an axis of the coil coincides with an axis of the stepper motor. That is to say, a width of the multi-winding stepper motor perpendicular to the axis is limited by the thicknesses of the magnets, of the claw poles, and of the coil, making it difficult to further reduce the width of the multi-winding stepper motor.

Therefore, it is necessary to provide a new stepper motor to address the above-mentioned technical problem.

### SUMMARY

The present disclosure aims to provide a new stepper motor, in order to address the problem in related technologies that it is difficult to further reduce the width of the multi-winding stepper motor.

To this end, the present disclosure provides a stepper motor including: two plates arranged opposite to each other; a rotary shaft having two ends supported on and in rotational connection with the two plates, respectively; a magnet sleeved and fixed on an outer periphery of the rotary shaft; and a stator unit sleeved on the rotary shaft. The two plates are arranged on both sides of the magnet in an axial direction of the rotary shaft and to space from the magnet, the stator unit includes a plurality of windings arranged to space from the magnet, and the plurality of windings are fixed between the two plates and are arranged along the axial direction of the rotary shaft. Each winding of the plurality of windings includes two respective claw poles arranged opposite to each other and sleeved on the rotary shaft and at least two respective solenoids fixed between the two respective claw poles, the at least two respective solenoids are arranged at intervals along a circumferential direction of the rotary shaft and arranged on both sides of the magnet, and each solenoid of the at least two respective solenoids includes a respective iron core fixed between the two respective claw poles and a respective coil wound on the respective iron core. Coils of the plurality of windings that align with each other along the axial direction of the rotary shaft have a same axis, every two adjacent windings of the plurality of windings are connected to each other by fixing two respective adjacent claw poles to each other, and two claw poles of the plurality of windings that are respectively adjacent to the two plates are fixed and connected to the two plates, respectively.

As an improvement, each winding of the plurality of windings includes two respective solenoids symmetrically arranged on both sides of the magnet.

As an improvement, currents generated in the coils of the plurality of windings in response to energizing the coils have a same direction.

As an improvement, currents generated in respective coils of every two adjacent windings of the plurality of windings in response to energizing the coils of the plurality of windings have opposite directions.

As an improvement, each claw pole of the two respective claw poles includes a respective fixing portion having an annular shape and a respective plurality of extension portions extending from an inner periphery of the respective fixing portion and along the axial direction of the rotary shaft, and the respective plurality of extension portions are arranged at intervals. Extension portions of one claw pole of the two respective claw poles extend towards an other claw pole of the two respective claw poles, and extension portions of the two respective claw poles are arranged to interleave with each other. The at least two respective solenoids are fixed between respective fixing portions of the two respective claw poles and are arranged to space from the extension portions of the two respective claw poles. Every two adjacent windings of the plurality of windings are connected to each other by connecting fixing portions of two respective adjacent claw poles to each other, and the two claw poles of the plurality of windings that are respectively adjacent to the two plates are fixed and connected to the two plates at fixing portions of the two claw poles, respectively.

As an improvement, each extension portion of the respective plurality of extension portions of one claw pole of the two respective claw poles extends between two respective extension portions of the respective plurality of extension portions of an other claw pole of the two respective claw poles.

As an improvement, the stepper motor includes a plurality of magnets arranged around the rotary shaft and fixed on the outer periphery of the rotary shaft.

As an improvement, a respective bearing is embedded and fixed in each plate of the two plates, and each plate of the two plates is sleeved on and fixed to a respective end of the rotary shaft via the respective bearing and is in rotational connection with the rotary shaft.

Compared with the related technologies, each winding of the stepper motor in the present disclosure includes at least two respective solenoids arranged at intervals along a circumferential direction of the rotary shaft and arranged on both sides of the magnet, and coils of the plurality of windings that align with each other along the axial direction of the rotary shaft have a same axis. In this way, the respective axis of each coil can be prevented from coinciding with the axis of the stepper motor. Accordingly, the width of the stepper motor in a direction perpendicular to the axial direction of the stepper motor can be free of the limitation of the thicknesses of coils, thereby further reducing the width of the stepper motor and achieving the thinnest design of the stepper motor. Moreover, by reducing the width of the stepper motor, the torque performance of the stepper motor can be further improved by adjusting the thicknesses of coils on condition that an overall width of the stepper motor is smaller than a total width of the plurality of windings arranged side by side.

### BRIEF DESCRIPTION OF DRAWINGS

In order to illustrate the technical solutions in the embodiments of the present disclosure more clearly, the drawings to be used in the illustration of the embodiments will be briefly described below. It is obvious that the drawings mentioned in the following illustration are only some embodiments of the present disclosure. For those of ordinary skill in the art, other drawings may be obtained in accordance with these drawings without any inventive effort.

FIG. 1 is a schematic diagram of a three-dimensional structure of the stepper motor according to some embodiments of the present disclosure.

FIG. 2 is an exploded view of a portion of the structure of the stepper motor according to some embodiments of the present disclosure.

FIG. 3 is a cross-sectional view taken along the A-A line in FIG. 1.

FIG. 4 is a schematic diagram of magnetic poles of a winding and directions of currents in the winding of the stepper motor according to some embodiments of the present disclosure.

FIG. 5 is a schematic diagram of magnetic poles of two adjacent windings and directions of currents in the two adjacent windings of the stepper motor according to some embodiments of the present disclosure.

In the drawings:
100—stepper motor; 1—rotary shaft; 2—magnet; 3—plate; 31—bearing; 4—winding; 41—claw pole; 411—fixing portion; 412—extension portion; 42—solenoid; 421—iron core; 422—coil.

### DETAILED DESCRIPTION OF EMBODIMENTS

The technical solutions in the embodiments of the present disclosure will be clearly and completely illustrated in conjunction with the accompanying drawings. Obviously, the illustrated embodiments are only a part of the embodiments of the present disclosure, not all of them. All other embodiments obtained by those skilled in the art based on the embodiments of the present disclosure without creative works fall within the scope of protection of the present disclosure.

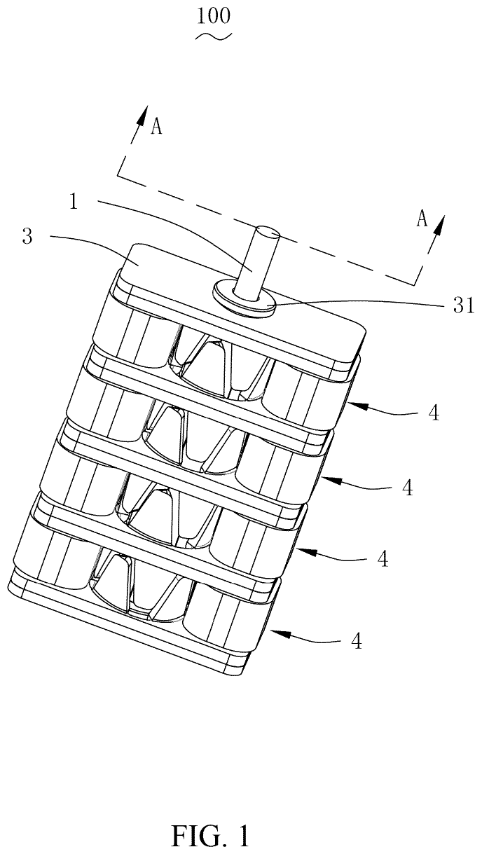

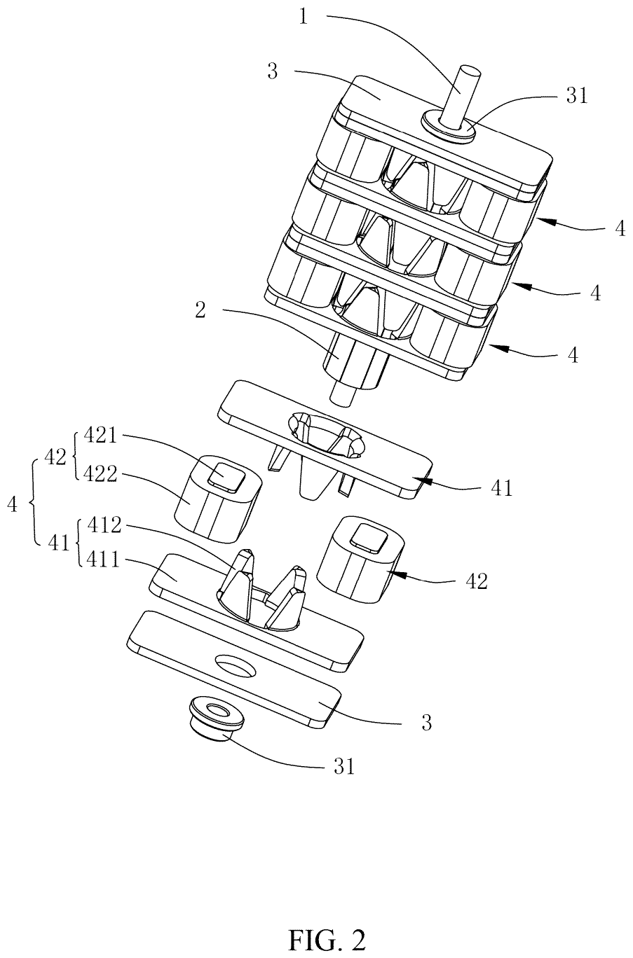

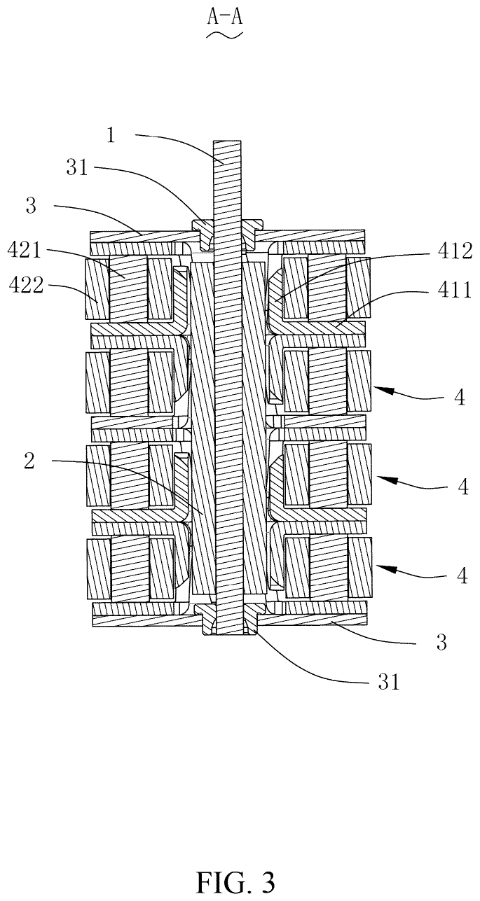

Embodiments of the present disclosure provide a stepper motor 100, referring to FIGS. 1 to 3, the stepper motor includes two plates 3 arranged opposite to each other, a rotary shaft 1 having two ends supported on and in rotational connection with the two plates 3, respectively, a magnet 2 sleeved and fixed on an outer periphery of the rotary shaft 1, and a stator unit sleeved on the rotary shaft.

In some embodiments, the stepper motor includes a plurality of magnets 2 arranged around the rotary shaft 1 and fixed on the outer periphery of the rotary shaft 1. In some embodiments, eight magnets 2 are provided.

In some embodiments, a respective bearing 31 is embedded and fixed in each plate 3, and each plate 3 is sleeved on and fixed to a respective end of the rotary shaft 1 via the respective bearing 31 and is in rotational connection with the rotary shaft 1. That is, the respective bearing 31 is in rotational connection with the rotary shaft 1, and each plate 3 is fixed on an outer periphery of the respective bearing 31.

:The stator unit includes a plurality of windings 4 arranged to space from the magnets 2, and the plurality of windings 4 are fixed between the two plates 3 and are arranged along the axial direction of the rotary shaft 1. In some embodiments, four windings 4 are provided.

Each winding 4 includes two respective claw poles 41 arranged opposite to each other and sleeved on the rotary shaft 1 and at least two respective solenoids 42 fixed between the two respective claw poles 41, the at least two respective solenoids 42 are arranged at intervals along a circumferential direction of the rotary shaft 1 and arranged on both sides of the magnets 2. In some embodiments, each winding 4 includes two respective solenoids 42 symmetrically arranged on both sides of the magnets 2. Depending on actual needs, each winding 4 may include four respective solenoids 42, with one pair of solenoids 42 being arranged on one side of the magnets 2, and the other pair of solenoids 42 being arranged on the other side of the magnets 2. Alternatively, each winding 4 may include six respective solenoids 42, with three solenoids 42 being arranged on one side of the magnets 2, and the remaining three solenoids 42 being arranged on the other side of the magnets 2.

In some embodiments, each claw pole 41 includes a respective fixing portion 411 having an annular shape and a respective plurality of extension portions 412 extending from an inner periphery of the respective fixing portion 411 and along the axial direction of the rotary shaft 1, and the respective plurality of extension portions 412 are arranged at intervals. The extension portions 412 of one claw pole 41 of the two respective claw poles extend towards the other claw pole 41, and extension portions 412 of the two respective claw poles 41 are arranged to interleave with each other. The at least two respective solenoids 42 are fixed between respective fixing portions 411 of the two respective claw poles 41 and are arranged to space from the extension portions 412 of the two respective claw poles 41. Every two adjacent windings of the plurality of windings 4 are connected to each other by connecting fixing portions 411 of two respective adjacent claw poles to each other, and the two claw poles 41 of the plurality of windings that are respectively adjacent to the two plates 3 are fixed and connected to the two plates 3 at fixing portions 411 of the two claw poles 41, respectively.

In some embodiments, each extension portion of the respective plurality of extension portions 412 of one claw pole of the two respective claw poles 41 extends between two respective extension portions of the respective plurality of extension portions 412 of the other claw pole of the two respective claw poles 41.

Each solenoid of the at least two respective solenoids 42 includes a respective iron core 421 fixed between the two respective claw poles 41 and a respective coil 422 wound on the respective iron core 421. The respective iron core 421 is fixed between the fixing portions 411 of the two respective claw poles 41, and coils 422 of the plurality of windings 4 that align with each other along the axial direction of the rotary shaft 1 have a same axis.

Every two adjacent windings of the plurality of windings 4 are connected to each other by fixing two respective adjacent claw poles 41 to each other, and two claw poles 41 of the plurality of windings 4 that are respectively adjacent to the two plates 3 are fixed and connected to the two plates 3, respectively. That is, every two adjacent windings 4 are fixedly connected to each other, and the outermost two windings 4 are fixedly connected to the two plates 3 respectively. Because each plate 3 is sleeved on the rotary shaft 1 and is in rotational connection with the rotary shaft 1, the claw poles 41 of the plurality of windings 4 are indirectly sleeved on the rotary shaft 1 via the plates 3 and are in rotational connection with the rotary shaft 1.

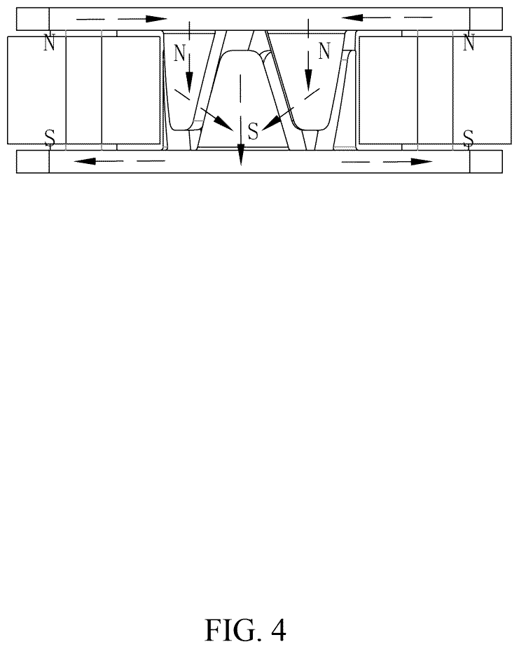

In some embodiments, when energizing the coils 422 of the two respective solenoids 42, the two respective polarized ends of each solenoid 42 form opposite magnetic poles, the polarized ends of the two respective solenoids 42 on the same side form identical magnetic poles, and the two respective claw poles 41 are polarized. That is, when energizing the coils 422 of the two respective solenoids 42 of each winding 4, the ends of each solenoid 42 are polarized to form N pole and S pole, respectively. The polarized ends of the two respective solenoids 42 on the same side form identical magnetic poles and polarize one of the two respective claw poles 41 that is on the same side. In this way, as shown in FIG. 4, the claw pole 41 close to the N poles of the solenoids 42 forms an N pole, and the claw pole 41 close to the S poles of the solenoids 42 forms an S pole.

When alternating current is applied to the coils 422 of the two respective solenoids 42 of each winding 4, the magnetic poles of the two respective claw poles 41 alternate, i.e. the magnetic poles formed by the two respective claw poles 41 alternate between N and S poles, thereby achieving the rotation of the stepper motor 100.

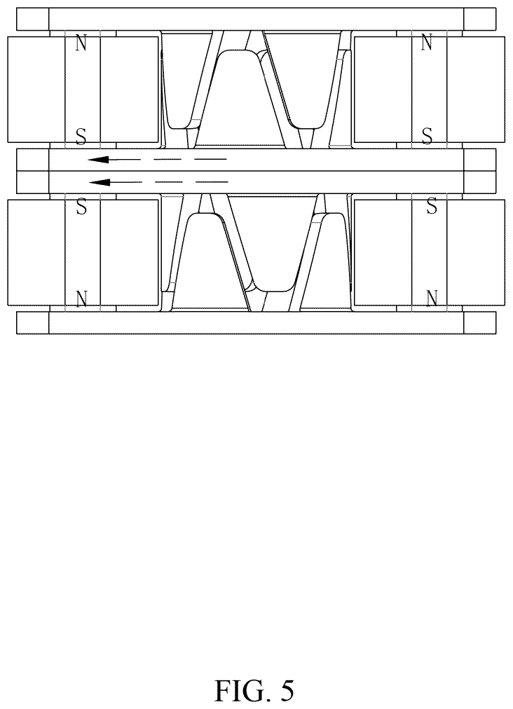

As shown in FIG. 5, currents generated in the coils 422 of the solenoids 42 of the plurality of windings 4 in response to energizing the coils 422 have a same direction. Alternatively, currents generated in respective coils 422 of the solenoids 42 of every two adjacent windings of the plurality of windings 4 in response to energizing the coils 422 of the plurality of windings 4 may have opposite directions. In this case, the solenoids 42 of adjacent windings form opposite magnetic poles. In this way, short circuits of magnetic field are less likely to occur in the electromagnetic field of the plurality of windings 4.

Compared with the related technologies, each winding 4 of the stepper motor 100 in the present disclosure includes at least two respective solenoids 42 arranged at intervals along a circumferential direction of the rotary shaft 1 and arranged on both sides of the magnet 2, and coils 422 of the plurality of windings 4 that align with each other along the axial direction of the rotary shaft 1 have a same axis. In this way, the respective axis of each coil 422 can be prevented from coinciding with the axis of the stepper motor 100. Accordingly, the width of the stepper motor 100 in a direction perpendicular to the axial direction of the stepper motor can be free of the limitation of the thicknesses of coils 422, thereby further reducing the width of the stepper motor 100 and achieving the thinnest design of the stepper motor 100. Moreover, by reducing the width of the stepper motor 100, the torque performance of the stepper motor 100 can be further improved by adjusting the thicknesses of coils 422 on condition that an overall width of the stepper motor 100 is smaller than a total width of the plurality of windings 4 arranged side by side. Furthermore, the stepper motor 100 in the present disclosure is simpler to use and has lower cost compared to the stepper motors in the related technologies.

The above are only embodiments of the present disclosure. It should be pointed out that those skilled in the art can make improvements without departing from the inventive concept of the present disclosure, and these improvements all fall within the scope of protection of the present disclosure.

What is claimed is:

1. A stepper motor, comprising:
two plates arranged opposite to each other;
a rotary shaft having two ends supported on and in rotational connection with the two plates, respectively;
a magnet sleeved and fixed on an outer periphery of the rotary shaft; and
a stator unit sleeved on the rotary shaft;
wherein the two plates are arranged on both sides of the magnet in an axial direction of the rotary shaft and to space from the magnet, the stator unit comprises a plurality of windings arranged to space from the magnet, and the plurality of windings are fixed between the two plates and are arranged along the axial direction of the rotary shaft;
wherein each winding of the plurality of windings comprises two respective claw poles arranged opposite to each other and sleeved on the rotary shaft and at least two respective solenoids fixed between the two respective claw poles, the at least two respective solenoids are arranged at intervals along a circumferential direction of the rotary shaft and arranged on both sides of the magnet, and each solenoid of the at least two respective solenoids comprises a respective iron core fixed between the two respective claw poles and a respective coil wound on the respective iron core; and
wherein coils of the plurality of windings that align with each other along the axial direction of the rotary shaft have a same axis, every two adjacent windings of the plurality of windings are connected to each other by fixing two respective adjacent claw poles to each other, and two claw poles of the plurality of windings that are respectively adjacent to the two plates are fixed and connected to the two plates, respectively.

2. The stepper motor according to claim 1, wherein each winding of the plurality of windings comprises two respective solenoids symmetrically arranged on both sides of the magnet.

3. The stepper motor according to claim 1, wherein currents generated in the coils of the plurality of windings in response to energizing the coils have a same direction.

4. The stepper motor according to claim 1, wherein currents generated in respective coils of every two adjacent windings of the plurality of windings in response to energizing the coils of the plurality of windings have opposite directions.

5. The stepper motor according to claim 1, wherein each claw pole of the two respective claw poles comprises a respective fixing portion having an annular shape and a respective plurality of extension portions extending from an inner periphery of the respective fixing portion and along the axial direction of the rotary shaft, and the respective plurality of extension portions are arranged at intervals;
wherein extension portions of one claw pole of the two respective claw poles extend towards an other claw pole of the two respective claw poles, and extension portions of the two respective claw poles are arranged to interleave with each other;
wherein the at least two respective solenoids are fixed between respective fixing portions of the two respective claw poles and are arranged to space from the extension portions of the two respective claw poles; and
wherein every two adjacent windings of the plurality of windings are connected to each other by connecting fixing portions of two respective adjacent claw poles to each other, and the two claw poles of the plurality of windings that are respectively adjacent to the two plates are fixed and connected to the two plates at fixing portions of the two claw poles, respectively.

6. The stepper motor according to claim 5, wherein each extension portion of the respective plurality of extension portions of one claw pole of the two respective claw poles extends between two respective extension portions of the respective plurality of extension portions of an other claw pole of the two respective claw poles.

7. The stepper motor according to claim 1, comprising a plurality of magnets arranged around the rotary shaft and fixed on the outer periphery of the rotary shaft.

8. The stepper motor according to claim 1, wherein a respective bearing is embedded and fixed in each plate of the two plates, and each plate of the two plates is sleeved on and fixed to a respective end of the rotary shaft via the respective bearing and is in rotational connection with the rotary shaft.
